(19) United States
(12) Patent Application Publication
(10) Pub. No.: US 2007/0236798 A1
(43) Pub. Date: Oct. 11, 2007

(54) Antireflective coating and substrates coated therewith

(76) Inventors: Larry J. Shelestak, Bairdford, PA (US); James P. Thiel, Pittsburgh, PA (US)

Correspondence Address: Jacques B. Miles;PPG Industries, Inc., One PPG Place, Pittsburgh, PA, 15272, US

(21) Appl. No.: 11/398,166

(22) Filed: Apr. 5, 2006

(51) Int. Cl. G02B 1/10

(52) U.S. Cl. 359/588

(57) ABSTRACT

An antireflective coating is disclosed. The antireflective coating includes a first high index of refraction coating layer; a first low index of refraction coating layer over the first high index of refraction coating layer; a second high index of refraction coating layer over the first low index of refraction coating layer; and
a second low index of refraction coating layer over the second high index of refraction coating layer, wherein the first high index of refraction coating layer has an optical thickness defined by the following equation within a range of ±25%: [−2.1643×(optical thickness of the second low index of refraction coating layer)²]+[4.6684×(optical thickness of the second low index of refraction coating layer)]−2.2187, or the first low index of refraction coating layer has an optical thickness defined by the following equation within a range of ±25%: [2.0567×(optical thickness of the second low index of refraction coating)²]−[3.5663×(optical thickness of the second low index of refraction coating)]+1.8467, or the second high index of refraction coating layer has an optical thickness defined by the following equation within a range of ±25%: [−0.3987×(optical thickness of the second low index of refraction coating layer)²]−[1.1576×(optical thickness of the second low index of refraction coating layer)]+2.7462.

### FIELD OF THE INVENTION

The present invention relates to antireflective coatings and substrates coated with such coatings.

### BACKGROUND

Substrates such as glass reflect light when light is incident upon them. Depending on the angle at which a person is viewing the substrate, the intensity of the reflected light is either more or less intense. Generally, as the viewing angle increases, the intensity of the light reflected from the surface increases. In some applications, this reflected light is objectionable to a viewer.

Techniques have been discovered that reduce the reflectance of a substrate. One technique for reducing the reflectance of a substrate is to roughen the surface of the substrate to provide a rough, anti-glare surface. Another technique for reducing the reflectance of a substrate is to deposit an antireflective coating over the surface of the substrate. The antireflective coating destructively interferes with light waves traveling through the coating to reduce the intensity of the light reflected from the substrate.

The present invention is directed to a novel antireflective coating and related coated substrates as well as a novel use of the antireflective coating.

### SUMMARY OF THE INVENTION

In a non-limiting embodiment, the present invention is an antireflective coating comprising: a first high index of refraction coating layer; a first low index of refraction coating layer over the first high index of refraction coating layer; a second high index of refraction coating layer over the first low index of refraction coating layer; and a second low index of refraction coating layer over the second high index of refraction coating layer, wherein the first high index of refraction coating layer has an optical thickness defined by the following equation within a range of ±25%: [−2.1643×(optical thickness of the second low index of refraction coating layer)²]+[4.6684×(optical thickness of the second low index of refraction coating layer)]−2.2187, or the first low index of refraction coating layer has an optical thickness defined by the following equation within a range of ±25%: [2.0567×(optical thickness of the second low index of refraction coating)²]−[3.5663×(optical thickness of the second low index of refraction coating)]+1.8467, or the second high index of refraction coating layer has an optical thickness defined by the following equation within a range of ±25%: [−0.3987×(optical thickness of the second low index of refraction coating layer)²]−[1.1576×(optical thickness of the second low index of refraction coating layer)]+2.7462.

In another non-limiting embodiment, the present invention is an antireflective coating comprising: a first high index of refraction coating layer; a first low index of refraction coating layer over the first high index of refraction coating layer; a second high index of refraction coating layer over the first low index of refraction coating layer; and a second low index of refraction coating layer over the second high index of refraction coating layer, wherein the first high index of refraction coating layer has an optical thickness defined by the following equation within a range of ±25%: 0.3061−[0.1022×(optical thickness of the second low index of refraction coating layer)]+[0.0515×(optical thickness of the second low index of refraction coating layer)²]; or the first low index of refraction coating layer has an optical thickness defined by the following equation within a range of ±25%: 0.2846+[0.1427×(optical thickness of the second low index of refraction coating layer)]−[0.0228×(optical thickness of the second low index of refraction coating layer)²]; or the second high index of refraction coating layer has an optical thickness defined by the following equation within a range of ≅25%: 2.2641+[0.0654×(optical thickness of the second low index of refraction coating layer)]−[0.1505×(optical thickness of the second low index of refraction coating layer)²].

In yet another embodiment, the present invention is a method for increasing the visible light transmittance of a substrate comprising providing a transparent substrate having a visible light transmittance; and depositing an antireflective coating over at least a portion of the substrate, whereby the visible light transmittance of the substrate after the antireflective coating has been deposited is at least 3% higher than it was before the coating was deposited.

### BRIEF DESCRIPTION OF THE INVENTION

All numbers expressing dimensions, physical characteristics, quantities of ingredients, reaction conditions, and the like used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1.0 to 7.8, 3.0 to 4.5, and 6.3 to 10.0.

As used herein, spatial or directional terms, such as “left”, “right”, “inner”, “outer”, “above”, “below”, “top”, “bottom”, and the like, are understood to encompass various alternative orientations and, accordingly, such terms are not to be considered as limiting.

As used herein, the terms “on”, “applied on/over”, “formed on/over”, “deposited on/over”, “overlay” and “provided on/over” mean formed, deposited, or provided on but not necessarily in contact with the surface. For example, a coating layer “formed over” a substrate does not preclude the presence of one or more other coating layers of the same or different composition located between the formed coating layer and the substrate. For instance, the substrate can include a conventional coating such as those known in the art for coating substrates, such as glass or ceramic.

The present invention is an antireflective coating comprising one or more coating stacks comprising (1) a high index of refraction coating layer and (2) a low index of refraction coating layer over the high index of refraction coating layer. As used above, the terms “high” and “low” are relative as the only condition of the high index of refraction coating layer is that it have an index of refraction that is higher (i.e. larger) than the index of refraction of the low index of refraction coating layer. The only requirement of the low index of refraction coating layer is that it have a lower index of refraction than the high index of refraction coating layer.

In a non-limiting embodiment of the invention, the antireflective coating comprises two coating stacks in sequence (i.e., there is a first high index of refraction coating layer; a first low index of refraction coating layer over the first high index of refraction coating layer; a second high index of refraction coating layer over the first low index of refraction coating layer; and a second low index of refraction coating layer over the second high index of refraction coating layer).

In a non-limiting embodiment, the high index of refraction coating layer is a metal alloy oxide layer, and the low index of refraction coating layer is a metal oxide layer. As used herein, “alloy” means a homogeneous mixture or solid solution of two or more metals, the atoms of one replacing or occupying interstitial positions between the atoms of the other. In this embodiment, the specific configuration of the antireflective coating is as follows: a first metal alloy oxide layer; a first metal oxide layer over at least a portion of the first metal alloy oxide layer; a second metal alloy oxide layer over at least a portion of the first metal oxide layer; and a second metal oxide layer over at least a portion of the second metal alloy oxide layer.

In a non-limiting embodiment of the invention, at least one of the metal alloy oxide layers comprises zinc stannate. As used herein, zinc stannate refers to a composition of ZnₓSn₁₋ₓO₂₋ₓ (Formula 1) where x varies in the range of 0 to 1. For example, x can be greater than 0 and any fraction or decimal less than 1.0. If x were equal to ⅔, for example, Formula 1 is Zn_{2/3}Sn_{1/3}O_{4/3} which is commonly described as “Zn₂SnO₄”. A zinc stannate containing film has one or more of the forms of Formula 1 in a predominant amount in the film.

In a non-limiting embodiment of the invention, the metal oxide layers comprise zirconia, titania, hafnia, silica, alumina, and mixtures or combinations thereof.

The various coating layers in the antireflective coating of the invention can be deposited using conventional deposition techniques such as sol gel techniques, chemical vapor deposition (“CVD”), spray pyrolysis, vacuum deposition techniques and magnetron sputtered vacuum deposition (“MSVD”), which are well known in the art.

Suitable CVD methods of deposition are described in the following references, which are hereby incorporated by reference: U.S. Pat. Nos. 4,853,257; 4,971,843; 5,464,657; 5,599,387; and 5,948,131.

Suitable spray pyrolysis methods of deposition are described in the following references, which are hereby incorporated by reference: U.S. Pat. Nos. 4,719,126; 4,719,127; 4,111,150; and 3,660,061.

Suitable MSVD methods of deposition are described in the following references, which are hereby incorporated by reference: U.S. Pat. Nos. 4,379,040; 4,861,669; and 4,900,633.

Other well known deposition techniques such as plasma enhanced CVD (“PECVD”) can also be used to deposit the antireflective coating.

In a non-limiting embodiment, the optical thicknesses of (a) the first high index of refraction coating layer, (b) the second high index of refraction coating layer and (c) the first low index of refraction coating layer is determined by the optical thickness of the second low index of refraction coating layer. As used herein, “optical thickness” means the product of the physical thickness of an isotropic optical element and its refractive index and is measured in quarter waves. As used herein, “quarter wave” means the physical layer thickness×4×refractive index/(reference wavelength of light). The reference wavelength of light is 550 nm.

In a non-limiting embodiment of the invention, the antireflective coating is used in a vehicle glazing and the second low index of refraction coating layer has an optical thickness ranging from 0.7 to 1.5 quarter waves, for example, from 0.71 to 1.45 quarter waves, or from 0.8 to 1.3 quarter waves, or from 0.9 to 1.1 quarter waves. This embodiment of the antireflective coating is designed to be used in vehicle glazings so the response of the coating is optimized for the wavelength of visible light (i.e., from 380 nm to 780 nm). Based on the optical thickness of the second low index of refraction coating layer, the optical thicknesses of the other coating layers are determined using the following equations.

The first high index of refraction coating layer has an optical thickness defined by the following equation (Equation 1): [−2.1643×(optical thickness of the second low index of refraction coating layer)²]+[4.6684×(optical thickness of the second low index of refraction coating layer )]−2.2187. The optical thickness of the first low index of refraction coating layer is defined by the following equation (Equation 2): [2.0567×(optical thickness of the second low index of refraction coating)²]−[3.5663×(optical thickness of the second low index of refraction coating)]+1.8467. The optical thickness of the second high index of refraction coating layer is defined by the following equation (Equation 3): [−0.3987×(optical thickness of the second low index of refraction coating layer)²]−[1.1576×(optical thickness of the second low index of refraction coating layer)]+2.7462.

The optical thicknesses of the respective coating layers, i.e., the optical thicknesses of (a) the first high index of refraction coating layer, (b) the first low index of refraction coating layer and (c) the second high index of refraction coating layer can vary by ±25% from the calculated values above; such as ±0%, or such as ≧5%.

For illustration purposes, if the optical thickness of the second low index of refraction coating layer is 0.96 quarter wave in the non-limiting embodiment above, the optical thickness of the second high index of refraction coating layer would be [−0.3987×(0.96)²][1.1576×(0.96)]+2.7462=1.2675 quarter wave. The first low index of refraction coating layer would have an optical thickness of 0.3184 quarter wave. The first high index of refraction coating layer would have an optical thickness of 0.2683 quarter wave.

Reiterating what was stated above. Because this embodiment of the antireflective coating is designed for use in vehicle glazings, the thicknesses of the coating layers determined by Equations 1-3 above optimize the visible light transmission of illuminant A as defined by the CIELAB method of color measurement through a glass substrate as perceived by the eye of a human being.

In the non-limiting embodiment described above, the antireflective coating can be deposited on the surface of a substrate to increase the visible light transmittance (Lta) exhibited by the substrate. For example, an uncoated substrate that exhibits an Lta of less than 70% (which is less than the legal requirement for a front windshield in the United States) can be coated with the antireflective coating of the invention to provide a coated substrate that exhibits an Lta of equal to or greater than 70%.

The antireflective coating of the present invention decreases the visible reflectance of the surface of the coated substrate by at least 2.5%, for example, at least 3% and increases the Lta by a similar amount. Since the Transmittance+Reflectance+Absorption=100%, decreasing the reflectance, increases the transmittance (Lta) when the amount of absorption is constant.

The antireflective coating of the present invention can be applied to any type of glass substrate. In a non-limiting embodiment, the substrate is a solar energy absorbing glass, i.e., a glass having one or more additives to enhance the luminous, infrared and/or ultraviolet radiation absorbing properties of the glass. Non-limiting examples of solar energy absorbing glass include Solextra® glass, Caribia® glass and Solargreen® glass, which are all commercially available from PPG Industries, Inc. (Pittsburgh, Pa.).

In a non-limiting embodiment, the antireflective coating of the invention is applied over a substrate that already contains a first coating such as a silver containing coating. As a result of the first coating, the Lta of the coated glass is less than 70%. The antireflective coating of the present invention increases the Lta of the coated substrate to equal to or greater than 70%.

In the non-limiting embodiment of the invention described above, the antireflective coating is deposited on a substrate, and the coated substrate is used in a vehicle glazing such as an automotive windshield. The coated substrate can be a vehicle glazing, and the antireflective coating can be deposited on the inside surface (as opposed to being applied to the surface exposed to external conditions) of the windshield.

The present invention also encompasses a method for increasing the visible light transmittance of a substrate comprising depositing the antireflective coating described above over a glass substrate, wherein the uncoated substrate exhibits an Lta less than 70% and the glass substrate coated with the antireflective coating exhibits an Lta of equal to or greater than 70%. The present invention also encompasses the resulting, coated glass substrate.

The method of the present invention provides a way for the Lta of a substrate to be raised without thinning the substrate. In certain instances, it is not desirable to thin substrates like glass because thicker substrates provide better acoustic noise performance which is important in many applications. Generally, glass substrates in vehicles that are less than 4.1 mm thick do not exhibit good acoustic noise performance.

In another non-limiting embodiment of the invention, the antireflective coating is used in a silicon solar cell. As a result, this embodiment is designed to optimize the transmission of light through a glass substrate as perceived by a silicon cell so the response of the coating is optimized for wavelengths ranging from 300 nm to 1600 nm. Based on the optical thickness of the second low index of refraction coating layer, the optical thicknesses of the other coating layers are determined using the following equations.

The first high index of refraction coating layer has an optical thickness defined by the following equation [Equation 4]: 0.3061−[0.1022×(optical thickness of the second low index of refraction coating layer)]+[0.0515×(optical thickness of the second low index of refraction coating layer)²]. The first low index of refraction coating layer has an optical thickness defined by the following equation [Equation 5]: 0.2846+[0.1427×(optical thickness of the second low index of refraction coating layer)]−[0.0228×(optical thickness of the second low index of refraction coating layer)²]. The second high index of refraction coating layer has an optical thickness defined by the following equation [Equation 6]: 2.2641+[0.0654×(optical thickness of the second low index of refraction coating layer)]−[0.1505×(optical thickness of the second low index of refraction coating layer)²].

The optical thicknesses of the respective coating layers, i.e., the optical thicknesses of (a) the first high index of refraction coating layer, (b) the first low index of refraction coating layer and (c) the second high index of refraction coating layer can vary by ±b 25% from the calculated values above; such as ±0%, or such as ±5%.

Thus, a non-limiting embodiment of a glass substrate coated with coating layers as determined using Equations 4-6 can provide a solar panel that demonstrates improved efficiency.

### EXAMPLES

The present invention is illustrated by the following non-limiting examples. Ex. 1 was a 4 inch by 4 inch (10 cm by 10 cm) uncoated Solextra® glass substrate that was 0.19 inches thick (0.49 cm). Ex. 2 was a 4 inch by 4 inch (10 cm by 10 cm) Solextra® glass substrate that was 0.19 inches thick (0.49 cm) coated with the antireflective coating of the present invention.

The antireflective coating included a first high index of refraction coating layer over the substrate; a first low index of refraction coating layer over the first high index of refraction coating layer; a second high index of refraction coating layer over the first low index of refraction coating layer; and a second low index of refraction coating layer over the second high index of refraction coating layer. Each high index of refraction coating layer was a metal alloy oxide comprising zinc stannate (52% zinc and 48% tin by weight). Each low index of refraction coating layer was a metal oxide comprising a mixture of silica and alumina (85% silica and 15% alumina by weight).

The desired optical thickness of the second low index of refraction coating layer was 0.96 quarter wave (88.83 nm). Based on Equation 3, the desired optical thickness of the second high index of refraction coating layer was [−0.3987×(0.96)²]−[1.1576×(0.96)]+2.7462=1.2675 quarter wave (84.72 nm). Based on Equation 2, the desired optical thickness of the first low index of refraction coating layer was 0.3184 quarter wave (29.46 nm). Based on Equation 1, the desired optical thickness of the first high index of refraction coating layer was 0.2683 quarter wave (17.94 nm).

The antireflective coating was deposited by magnetron sputtering vacuum deposition (MSVD). The various coating layers were deposited using mid-frequency, bi-polar, pulsed dual magnetron reactive sputtering in an Airco ILS 1600 coater, as is well known in the art. Power was provided by an Advanced Energy (AE) Pinnacle® Dual DC power supply and Astral® switching accessory, that converted the DC supply to a bi-polar, pulsed supply. The Airco ILS 1600 MSVD coater had a typical oxygen/argon atmosphere.

Ex. 3 was a 4 inch by 4 inch (10 cm by 10 cm) uncoated Solargreen® glass substrate having a thickness of 0.06 inches (0.16 cm). Ex. 4 was a 4 inch by 4 inch (10 cm by 10 cm) Solargreen® glass substrate having a thickness 0.06 inches (0.16 cm) coated with the antireflective coating of the invention. The antireflective coating had the same composition and layer thickness as described above and was deposited in the same manner described above.

Ex. 5 was a 4 inch by 4 inch (10 cm by 10 cm) uncoated Caribia® glass having a thickness of 0.19 inches thick (0.49 cm). Ex. 6 is a 4 inch by 4 inch (10 cm by 10 cm) Caribia® glass substrate having a thickness of 0.19 inches thick (0.49 cm) coated with the antireflective coating of the invention. The antireflective coating had the same composition and layer thickness as described above and was deposited in the same manner described above.

The visible light transmittance (Lta), total solar infrared transmittance (TSIR), total solar energy transmittance (TSET) and visible light reflectance (Rvis) of the examples were measured as described below.

All solar transmittance data are calculated using a Parry Moon air mass 2. The transmittance values are integrated over the wavelength range using the Rectangular Rule as is well known in the art. The spectral properties of the Examples were measured using a Perkin Elmer Lambda 9 spectrophotometer.

The Lta represents a computed value based on measured data using C.I.E. 1931 standard illuminant “A” and 2° standard observer over the wavelength range of 380 to 770 nanometers at 10 nanometer intervals.

The TSIR represents a computed value based on measured data over the wavelength range of 800 to 2100 nanometers at 50 nanometer intervals.

The TSET represents a computed value based on measured data over the wavelength range of 300 to 2100 nanometers at 50 nanometer intervals.

The Rvis represents a computed value based on measured data over the wavelength range of 380 to 770 nanometers at 10 nanometer intervals as determined using the WINDOWS (Version 4.0-4.1) software commercially available from the Lawrence Berkeley National Laboratory, which is based on ASTM 891, 2° observer.

Table 1 contains the measured performance properties of the examples.

TABLE 1
Performance Properties for the Exemplary Substrates

| | Ex. 1 | Ex. 2 | Ex. 3 | Ex. 4 | Ex. 5 | Ex. 6 |
|---|---|---|---|---|---|---|
| Lta | 72.1 | 74.9 | 81.4 | 84.7 | 68.1 | 71.1 |
| TSIR | 18.1 | 16.8 | 45.9 | 42.8 | 13.1 | 12.2 |
| TSET | 44.0 | 44.1 | 62.2 | 61.8 | 38.2 | 38.8 |
| Rvis | 7.0 | 3.3 | 7.6 | 3.8 | 6.7 | 2.8 |

Conclusion

The Examples show the antireflective coating of the invention can be used to increase the Lta of various substrates. The TSET values of the coated substrate remained within 1% of the original value for the uncoated glass substrate. Examples 5 and 6 demonstrate the antireflective coating of the present invention can be deposited on a substrate to raise the Lta above 70% and make the substrate suitable for use as an automotive glazing.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the appended claims and any and all equivalents thereof.

We claim:

1. An antireflective coating comprising:
a first high index of refraction coating layer;
a first low index of refraction coating layer over the first high index of refraction coating layer;
a second high index of refraction coating layer over the first low index of refraction coating layer; and
a second low index of refraction coating layer over the second high index of refraction coating layer, wherein
the first high index of refraction coating layer has an optical thickness defined by the following equation within a range of ±25%: [−2.1643×(optical thickness of the second low index of refraction coating layer)²]+[4.6684×(optical thickness of the second low index of refraction coating layer)]−2.2187, or
the first low index of refraction coating layer has an optical thickness defined by the following equation within a range of ±25%: [2.0567×(optical thickness of the second low index of refraction coating)²]−[3.5663×(optical thickness of the second low index of refraction coating)]+1.8467, or
the second high index of refraction coating layer has an optical thickness defined by the following equation within a range of ±25%: [−0.3987×(optical thickness of the second low index of refraction coating layer)²]−[1.1576×(optical thickness of the second low index of refraction coating layer)]+2.7462.

2. The antireflective coating according to claim 1, wherein the high index of refraction coating layer comprises a metal alloy oxide.

3. The antireflective coating according to claim 2, wherein the metal alloy oxide comprises zinc stannate.

4. The antireflective coating according to claim 1, wherein the low index of refraction coating layer comprises a metal oxide.

5. The antireflective coating according to claim 4, wherein the metal oxide comprises zirconia, titania, hafnia, silica, alumina, and mixtures or combinations thereof.

6. The antireflective coating according to claim 1, wherein the second low index of refraction coating layer has an optical thickness ranging from 0.7 to 1.5 quarter waves.

7. A coated substrate comprising:
a substrate; and
an antireflective coating comprising a first high index of refraction coating layer; a first low index of refraction coating layer over the first high index of refraction coating layer; a second high index of refraction coating layer over the first low index of refraction coating layer; and a second low index of refraction coating layer over the second high index of refraction coating layer, wherein
the first high index of refraction coating layer has an optical thickness defined by the following equation within a range of ±25%: [−2.1643×(optical thickness of the second low index of refraction coating layer)²]+[4.6684×(optical thickness of the second low index of refraction coating layer)]−2.2187, or
the first low index of refraction coating layer has an optical thickness defined by the following equation within a range of ±25%: [2.0567×(optical thickness of the second low index of refraction coating)²]−[3.5663×(optical thickness of the second low index of refraction coating)]+1.8467, or
the second high index of refraction coating layer has an optical thickness defined by the following equation within a range of ±25%: [−0.3987×(optical thickness of the second low index of refraction coating layer)²]−[1.1576×(optical thickness of the second low index of refraction coating layer)]+2.7462.

8. The coated substrate according to claim 7, wherein the substrate comprises solar energy absorbing glass.

9. The coated substrate according to claim 7 used in a vehicle glazing.

10. An antireflective coating comprising:
a first high index of refraction coating layer;
a first low index of refraction coating layer over the first high index of refraction coating layer;
a second high index of refraction coating layer over the first low index of refraction coating layer; and
a second low index of refraction coating layer over the second high index of refraction coating layer, wherein
the first high index of refraction coating layer has an optical thickness defined by the following equation within a range of ±25%: 0.3061−[0.1022×(optical thickness of the second low index of refraction coating layer)]+[0.0515×(optical thickness of the second low index of refraction coating layer)²]; or
the first low index of refraction coating layer has an optical thickness defined by the following equation within a range of ±25%: 0.2846+[0.1427×(optical thickness of the second low index of refraction coating layer)]−[0.0228×(optical thickness of the second low index of refraction coating layer)²]; or
the second high index of refraction coating layer has an optical thickness defined by the following equation within a range of ±25%: 2.2641+[0.0654×(optical thickness of the second low index of refraction coating layer)]−[0.1505×(optical thickness of the second low index of refraction coating layer)²].

11. The antireflective coating according to claim 10, wherein the high index of refraction coating layer comprises a metal alloy oxide.

12. The antireflective coating according to claim 11, wherein the metal alloy oxide comprises zinc stannate.

13. The antireflective coating according to claim 10, wherein the low index of refraction coating layer comprises a metal oxide.

14. The antireflective coating according to claim 13, wherein the metal oxide comprises zirconia, titania, hafnia, silica, alumina, and mixtures or combinations thereof.

15. A coated substrate comprising:
a substrate; and
an antireflective coating comprising a first high index of refraction coating layer; a first low index of refraction coating layer over the first high index of refraction coating layer; a second high index of refraction coating layer over the first low index of refraction coating layer; and a second low index of refraction coating layer over the second high index of refraction coating layer, wherein
the first high index of refraction coating layer has an optical thickness defined by the following equation within a range of ±25%: 0.3061−[0.1022×(optical thickness of the second low index of refraction coating layer)]+[0.0515×(optical thickness of the second low index of refraction coating layer)²]; or
the first low index of refraction coating layer has an optical thickness defined by the following equation within a range of ±25%: 0.2846+[0.1427×(optical thickness of the second low index of refraction coating layer)]−[0.0228×(optical thickness of the second low index of refraction coating layer)²]; or
the second high index of refraction coating layer has an optical thickness defined by the following equation within a range of ±25%: 2.2641+[0.0654×(optical thickness of the second low index of refraction coating layer)]−[0.1505×(optical thickness of the second low index of refraction coating layer)²].

16. The coated substrate according to claim 15 used in a silicon solar cell.

17. A method for increasing the visible light transmittance of a substrate comprising:
providing a transparent substrate having a visible light transmittance; and
depositing an antireflective coating over at least a portion of the substrate, whereby the visible light transmittance of the substrate after the antireflective coating has been deposited is at least 3% higher than it was before the coating was deposited.

18. The method according to claim 17, wherein the substrate has a visible light transmittance of less than 70% before depositing step and a visible light transmittance of at least 70% after the depositing step.
